(19) United States
(12) Patent Application Publication
(10) Pub. No.: US 2004/0195380 A1
(43) Pub. Date: Oct. 7, 2004

(54) Rotatable nozzle with nonaligning fluid supply

(76) Inventors: Michael R. Wall, Sandown, NH (US); Bruce Connolly, Gilmanton, NH (US); Francis Munjone, Epsom, NH (US)

Correspondence Address: PRAXAIR, INC., LAW DEPARTMENT - M1 557, 39 OLD RIDGEBURY ROAD, DANBURY, CT, 06810-5113, US

(21) Appl. No.: 10/388,452

(22) Filed: Mar. 17, 2003

(51) Int. Cl. B05B 1/32

(52) U.S. Cl. 239/451

(57) ABSTRACT

A rotatable nozzle assembly (13) having a nonaligned fluid (water) supply (7-2) disposed in such a way that the water supply (7) is perpendicular to the rotating axis of the nozzle (13) and arranged such that water supplied perpendicular to the rotating axis of the nozzle will be bent to be in alignment with and next to the axis of the nozzle to produce a concise small nozzle assembly that is adaptable to stripping coatings on internal surfaces of tubes or the like.

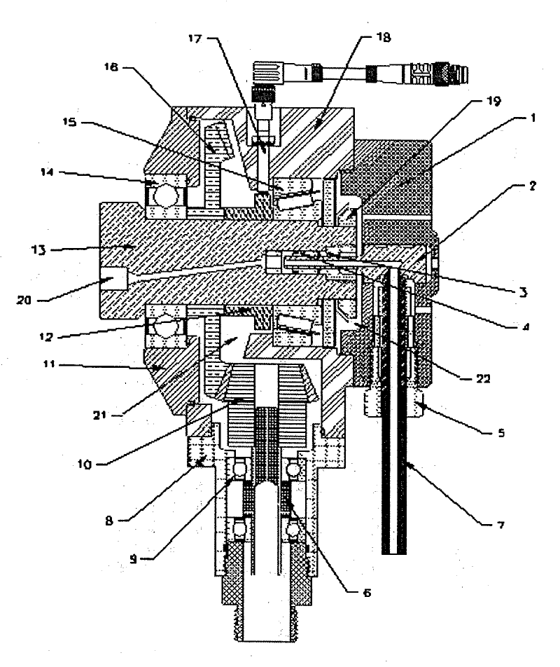

### FIELD OF THE INVENTION

The present invention relates generally to a spray and/or stripping rotatable nozzle assembly preferably utilized for stripping surfaces having a defined volume such as the internal surface of elongated tubes or IGT combustor baskets, transitions and the like.

### BACKGROUND OF THE INVENTION

There are many different types of nozzles for use with fluids to remove coatings from surfaces. Generally the fluid, such as water, is sprayed at high pressures so that the forces of the spray will be sufficient to remove or strip the undesirable coating without damaging the surface to be treated. High pressure water jet stripping has been used successfully for over a decade to remove old worn thermal spray coatings so that new thermal spray coatings can be reapplied. The water jet stripping process uses water at pressures to 75,000 psi to remove thermal spray coatings. Other industrial processes used to remove thermal spray coating are grit blasting, machining and chemical stripping. Water jet stripping offers significant economical advantages over these other two processes in that waterjet stripping is environmentally friendly, non-destructive to the part and significantly faster than both the other processes. A particular problem is the removal of thermal barrier coatings from industrial gas turbine (IGT) combustor baskets and transitions. Presently, water jet stripping nozzles are used to strip coatings from parts where clear stripping nozzle access to the coating is provided on outside diameters of the parts being stripped. The present day water jet stripping nozzles are large, restrictive and do not allow access to the internal diameter or parts such as thermal barrier coating surfaces of the IGT combustor baskets and transitions. Therefor, grit blast and chemical stripping are most often used to remove these coatings from the internal surfaces of thermal spray coated parts.

### OBJECTS OF THE INVENTION

It is an object of the present invention to provide a rotatable nozzle assembly that will allow for the efficient and effective removal of coatings from parts that presently can not be stripped using high pressure waterjet.

It is another object of the present invention to provide a rotatable nozzle assembly with a nozzle body having at least two orifices and power means for rotating and controlling the rotation of the nozzle body.

It is another object of the present invention to provide a rotatable nozzle assembly with fluid (such as water) dispensing means that permits the bending of the fluid from being parallel to the axis of the rotatable nozzle to a perpendicular flow aligned with the axis of the rotatable nozzle so as to conserve space and permit the nozzle assembly to be used in stripping the internal surface of tubes or the like.

### BRIEF DESCRIPTION OF THE DRAWING

The sole drawing is a vertical section of the rotatable nozzle assembly of the present invention.

### SUMMARY OF THE INVENTION

The invention is a nozzle assembly comprising a rotatable nozzle body with a rotating axis and having a first surface with at least one orifice defining an opening through the nozzle body, a first hollow tube disposed at an angle of between about 70° and about 110° with the rotating axis of the nozzle body and a first end adapted for receiving a fluid, such as water, and the second end in communication with a first end of a second hollow tube disposed at an angle between about 0° and about 30° with the rotating axis of the nozzle body, and having a second end being in alignment with the opening in the nozzle body so that any fluid fed through the first tube will be bent into the second tube and through the opening in the nozzle body. Preferably, the first and second tube could be a single bent unit.

Preferably, the first tube should be disposed at an angle between 85° and 95° with the rotating axis of the nozzle body. The latter embodiment of 90° will provide a more concise size for the nozzle assembly.

Preferably, this second tube should be disposed at an angle between 0° and 15° and more preferably about 0° with the rotating axis of the nozzle body. The latter embodiment of about 0° will provide a better alignment for the fluid fed through the opening in the nozzle body. Preferably the nozzle body should have at least two orifices, more preferably at least four orifices and most preferably, about six orifices. However, for some uses, more than six orifices may be desirable. The diameter of the orifices can be varied and could be between 0.002 and 0.016 inch and the size of the individual orifice within a single nozzle body can be varied. The preferable size for the orifice can be between 0.004 inch and 0.016 inch.

For stripping operations, it is desirable to pressurize the fluid to provide the necessary force for stripping. Preferably, a pressure of between about 20,000 psi and 60,000 psi would be suitable for most applications. Applying a high pressured fluidjet to strip a coating could not only remove the coating but could also penetrate the base material. In order to prevent damage to the base material and in accordance with the invention, it is necessary to rotate the nozzle body so that the force directed to the coated member from the pressurized fluidjet will be moving and thus not damaging the base material. For most applications, it is desirable to have a rotation speed preferably between about 500 and about 900 rpm, and most preferably about 800 rpm for the nozzle body. Once the speed is selected, it is preferable to keep the speed constant to insure that no damage is done to the base material.

Preferably, the width of the nozzle assembly along the rotating axis of the nozzle body is no more than 1.5 times the length of the rotating axis of the nozzle body, more preferably no more than 1.3 times the length of the rotating axis and most preferably no more than 1.2 times the length of the rotating axis.

The preferred fluid is water since it is environmentally friendly, non-destructive to the part being serviced and economical. In some applications, the fluid could be chemical fluid to more efficiently remove specifically coated material or to remove undesirable surface materials.

A novel embodiment of a water jet stripping nozzle of this invention, allows access to the inside of IGT transitions and baskets providing 55,000 psi water pressure to the coating stripping task at a rotation speed of about 800 rpm. The novel nozzle assembly of the invention will also allow water jet stripping and cleaning of other applications, such as aircraft jet engines, which require a small compact nozzle design that presently can not be considered for waterjet stripping. The rotatable nozzle of this invention can be used to strip thermal spray coatings from all configurations of parts. The nozzle may be configured to operate one to six orifices, with water pressures ranging from 20,000 psi to 75,000 psi. Nozzle rotation speeds may be used between 400 and 900 rpm. The most effective striping parameter for removing zirconia based thermal barrier and nickel-aluminum bond coat may be 55,000 psi, 800 rpm nozzle rotation, and 1 inch standoff. The assembly could be packaged and sold within a large water jet stripping system.

### DESCRIPTION OF THE PREFERRED EMBODIMENT

Referring now more particularly to the sole drawing, there is, as shown, a rotating six orifice nozzle located at the end of a nozzle assembly 13. The rotating nozzle contains up to six orifices 20 (only one orifice shown) each located at different diameters radial from the center of the nozzle face. Each orifice is configured with a different diameter orifice between 0.002 inch diameter to 0.016 inch diameter. The combined area of the orifices determines maximum water flow rate through the nozzle. The orifices are precision jeweled orifices and the size is selected to offer the best stripping profile to a particular application. High pressure water is introduced into the rotating nozzle by the high pressure stem 2. Coming from a high pressure intensifier (not shown), the high pressure water is delivered to the ID nozzle in a 304 SS tube, ⅜″ OD, 3/32″ ID 7. The ⅜″ tubing mates with the high pressure stem 2 by means of a high pressure cone and threaded joint. The seal is made at the coned mating surface and is further facilitated by a locking jamb nut 5. The water enters the stem radially from the nozzle rotation axis and then is turned 90 degrees now running axial to the nozzle rotation axis and along the center axis of rotation. The high pressure water travels along the internal diameter of the stem exiting into the rotating nozzle 20. The high pressure water is captivated within the rotating nozzle by the rotating seal 4 that seals between the stem outside diameter and the rotating nozzle inside diameter. The high pressure water now travels in the internal passages of the rotating nozzle 13 to each of the nozzle orifices 20.

The nozzle rotation and drive train (not shown) provides rotation for the six orifice rotating nozzle 13. Power transmission is delivered to the internal diameter nozzle by means of a flexible drive shaft. A 2 HP AC motor driven by a variable speed drive powers the flexible drive shaft. The flexible drive shaft (not shown) connects to one end of a short drive shaft 6 in the nozzle. The short drive shaft 6 is contained by two deep groove ball bearings 9. Attached to the opposite end of the drive shaft is a beveled gear set 10 and 16. The beveled gear set 10 and 16 provides 90° drive transmission and approximately 3:1 speed reduction. The beveled gear set 10 and 16 delivers rotary motion transmission to the 6 rotating orifice nozzle 13. The forces applied to the rotary nozzle 13 are contained by two main bearings. A rear taper rolled bearing 15 located within the nozzle assembly absorbs internal load forces. Rotary nozzle concentricity at the front of the nozzle is maintained by a deep groove ball bearing 14.

The nozzle housing is made from various grades of stainless steel and provides overall structural integrity for the nozzle's operations. Mounting holes located on the outside surface of the housing provide a means for mounting the nozzle to a robot. The internal spaces of the nozzle provide either grease lubrication cavity 21 for the nozzle rotation transmission components or a water leakage cavity 22 at the back of the nozzle. The grease cavity 21 contains a good quality grease. The water leakage cavity 22 contains weep holes that will allow water to leak out of the nozzle without being trapped at high pressure.

A nozzle rpm speed sensor 17 can be an inductive proximity switch. The inductive proximity switch can provide a pulsed frequency signal that can be converted to represent nozzle rotational speed. If loss of nozzle rotation during coating stripping operation is detected then immediate action can be taken to shut down the high-pressure water to prevent damage to the base material.

Other components of the rotatable nozzle assembly 13 are a nozzle back cap 1, high pressure nozzle seal retainer plug 3, short drive shaft housing 8, nozzle front cap 11, spacer proximity switch target 12, nozzle body 18, and bearing preload retainer nut 19.

From the foregoing, it can be seen that the novel rotatable nozzle assembly of this invention is adapted for efficiently discharging a rotating pressurized fluidjet adapted for stripping a coating in a confined area, such as the internal surface of a tube or other confined area.

Those skilled in the art will recognize that changes may be made to the nozzle assembly described in detail herein, without departing in the scope or spirit from the present invention as more particularly defined in the claims below.

What is claimed:

1. A nozzle assembly comprising a rotatable nozzle body with a rotating axis and having a first surface with at least one orifice defining an opening through the nozzle body; a first hollow tube disposed at an angle of between about 70° and about 110° with the rotating axis of the nozzle body and said first tube having a first end adapted for receiving a fluid and a second end in communication with a first end of a second hollow tube disposed at an angle between about 0° and about 30° with the rotating axis of the nozzle body and having a second end being in alignment with the opening in the nozzle body so that any fluid fed through the first tube will be bent into the second tube and then through the opening in the nozzle body.

2. The nozzle assembly of claim 1 wherein the first tube and second tube form a single unit comprising a bent tube.

3. The nozzle assembly of claim 1 wherein the angle between the first tube and the rotating axis of the nozzle body is between about 85° to about 95°.

4. The nozzle assembly of claim 1 wherein the angle between the first tube and the rotating axis of the nozzle body is about 90°.

5. The nozzle assembly of claim 1 wherein the angle between the second tube and the rotating axis of the nozzle body is between 0° to about 15°.

6. The nozzle assembly of claim 1 wherein the angle between the second tube and the rotating axis of the nozzle body is about 0°.

7. The nozzle assembly of claim 6 wherein the angle between the first tube and the rotatable nozzle of the nozzle body is about 90°.

8. The nozzle assembly of claim 1 wherein the said first surface of the nozzle body has at least two orifices.

9. The nozzle assembly of claim 1 wherein said first surface of the nozzle body has six orifices.

10. The nozzle assembly of claim 7 wherein said first surface of the nozzle body has six orifices.

11. The nozzle assembly of claim 1 wherein the diameter of the said at least one orifice is between about 0.002 inch and about 0.016 inch.

12. The nozzle assembly of claim 4 wherein the diameter of the said at least one orifice is between about 0.002 inch and about 0.016 inch.

13. The nozzle assembly of claim 1 wherein the width of the nozzle assembly along the rotating axis of the nozzle body is no larger than 1.5 times the length of the rotating axis of the nozzle body.

14. The nozzle assembly of claim 13 wherein the width of the nozzle assembly along the rotating axis of the nozzle body is no larger than 1.2 times the length of the rotating axis of the nozzle body.

15. The nozzle assembly of claim 14 wherein the said first surface of the nozzle body has at least two orifices.

16. The nozzle assembly of claim 15 wherein the diameter of the said orifices is between about 0.002 inch and about 0.016 inch.

17. A process for removing coating material from a confined surface area comprising the steps of preparing a nozzle assembly in accordance with claim 1; feeding a pressurized fluid into and through the nozzle body of the nozzle assembly, rotating the nozzle body to produce a moving pressurized fluidjet spray, and directing the pressurized moving fluidjet onto the coated surface area to effectively remove the coating from said surface area.

18. The process of claim 17 wherein the fluid is water and wherein the water is pressurized in a range between about 20,000 psi and about 60,000 psi.

19. The process of claim 18 wherein the nozzle body is rotated at a speed between about 400 and about 900 rpm.

20. The process of claim 19 wherein the coating material is a zirconia based thermal barrier coating or nickel-aluminum bond coating; wherein pressure about 55,000 psi; and wherein said nozzle body is rotated at a speed of about 800 rpm.
